(19) United States
(12) Patent Application Publication
(10) Pub. No.: US 2026/0317040 A1
(43) Pub. Date: Oct. 15, 2026

(54) DESICCANT PACKAGE AND PACKAGING BAG

(71) Applicant: Wiwynn Corporation, New Taipei City (TW)

(72) Inventors: HSIN-HUA LIN, New Taipei City (TW); Jing-Suei Gao, New Taipei City (TW); Hui-Wen Zhang, New Taipei City (TW)

(21) Appl. No.: 19/420,919

(22) Filed: Dec. 16, 2025

Related U.S. Application Data
(60) Provisional application No. 63/788,195, filed on Apr. 14, 2025.

(30) Foreign Application Priority Data
Sep. 26, 2025 (TW) 114137276

(51) Int. Cl. B65D 81/26; C08J 7/043; C08J 7/044; D21H 19/12; D21H 19/74; D21H 19/80; D21H 25/00; D21H 25/06

(52) U.S. Cl. CPC B65D 81/261; C08J 7/043; C08J 7/044; D21H 19/12; D21H 19/74; D21H 19/80; D21H 25/005; D21H 25/06

(57) ABSTRACT

A desiccant package includes a packaging bag and a desiccant. The packaging bag includes a breathable eco-friendly base material, an antistatic layer and a protective layer. The breathable eco-friendly base material forms a bag shape. The antistatic layer is disposed on an outer side of the breathable eco-friendly base material and includes an antistatic agent. The protective layer is disposed on one side of the antistatic layer located farther away from the breathable eco-friendly base material. The desiccant is accommodated in the packaging bag.

### CROSS-REFERENCE TO RELATED APPLICATIONS

This non-provisional application claims priority under 35 U.S.C. § 119(a) on Provisional Application No(s). 63/788,195 filed in U.S.A. on Apr. 14th, 2025, and Patent Application No(s). 114137276filed in Taiwan, R.O.C. on Sep. 26th, 2025, the entire contents of which are hereby incorporated by reference.

### TECHNICAL FIELD

The disclosure relates to a desiccant package and a packaging bag.

### BACKGROUND

Generally, a packaging of a product is typically provided with an antistatic desiccant packet, which can absorb moisture in the packaging and prevent the generation of static electricity, thereby avoiding damage to the product caused by moisture and static. However, conventional desiccant packets typically use Tyvek paper for the bag body. Tyvek paper is made from high-density polyethylene, and this material is non-biodegradable and thus may pose environmental burdens, making it difficult to meet eco-friendly requirements. Accordingly, how to address the aforementioned issue is one of the topics in this field.

### SUMMARY

The disclosure provides a desiccant package and a packaging bag, which not only maintain the original antistatic functionality but also meet eco-friendly requirements.

One embodiment of the disclosure provides a desiccant package. The desiccant package includes a packaging bag and a desiccant. The packaging bag includes a breathable eco-friendly base material, an antistatic layer and a protective layer. The breathable eco-friendly base material forms a bag shape. The antistatic layer is disposed on an outer side of the breathable eco-friendly base material and includes an antistatic agent. The protective layer is disposed on one side of the antistatic layer located farther away from the breathable eco-friendly base material. The desiccant is accommodated in the packaging bag.

Another embodiment of the disclosure provides a packaging bag. The packaging bag is adapted to accommodate a desiccant. The packaging bag includes a breathable eco-friendly base material, an antistatic layer and a protective layer. The breathable eco-friendly base material forms a bag shape to accommodate the desiccant. The antistatic layer is disposed on an outer side of the breathable eco-friendly base material and includes an antistatic agent. The protective layer is disposed on one side of the antistatic layer located farther away from the breathable eco-friendly base material.

According to the desiccant package and the packaging bag as disclosed in the above embodiments, by configuring the packaging bag to include the breathable eco-friendly base material , which forms the bag-shape to accommodate the desiccant, and the antistatic layer disposed on the outer side of the breathable eco-friendly base material and including the antistatic agent, the packaging bag can achieve antistatic functionality while also being recyclable and environmentally friendly in compliance with ESG and SDGs principles.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a cross-sectional view of a desiccant package according to some embodiments of the disclosure;

FIG. 2 is a partial cross-sectional view of a packaging bag according to some embodiments of the disclosure; and

FIG. 3 is a partial cross-sectional view of a packaging bag according to some embodiments of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

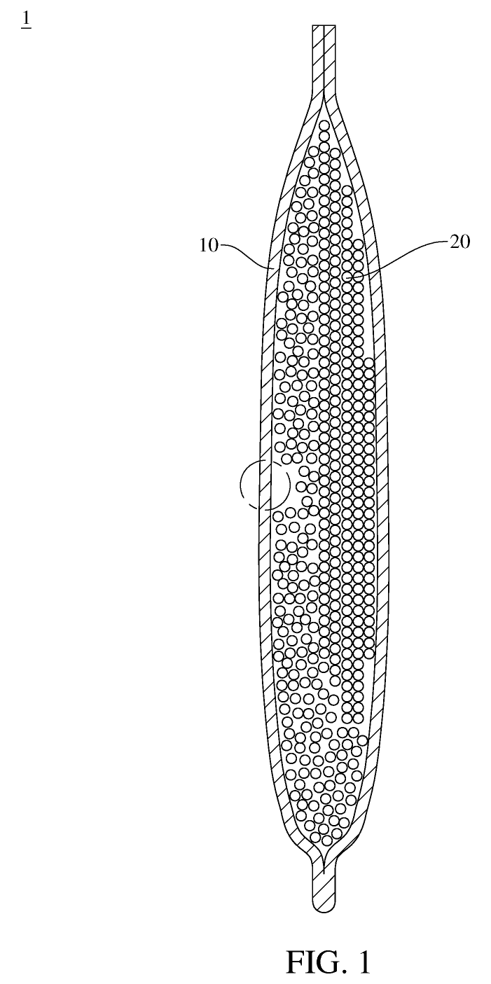

Referring to FIG. 1, FIG. 1 is a cross-sectional view of a desiccant package 1 according to some embodiments of the disclosure. The structural features of FIG. 1 can be applied to other embodiments of the disclosure.

The desiccant package 1 includes a packaging bag 10 and a desiccant 20 accommodated in the packaging bag 10. The desiccant 20 is configured to absorb moisture in the environment where the desiccant package 1 is placed. The desiccant 20, for example, may be a mineral-based material (e.g., clay) with a neutral pH, exhibiting physical moisture absorption. After absorbing moisture, the desiccant 20 does not swell or turn into a liquid, and it does not cause corrosion when in contact with metal products. Moreover, it is an environmentally friendly material compliant with ESG and SDGs principles. However, depending on practical requirements, the desiccant 20 may also be selected from other environmentally friendly materials and is not limited to mineral-based materials.

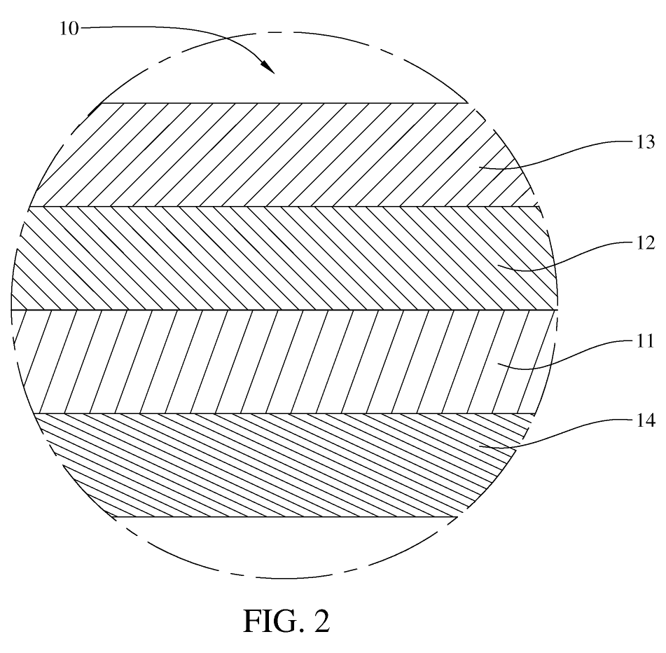

Then, referring to FIG. 2, FIG. 2 is a partial cross-sectional view of the packaging bag 10 according to some embodiments of the disclosure. The structural features of FIG. 2 can be applied to other embodiments of the disclosure.

The packaging bag 10 includes a breathable eco-friendly base material 11, an antistatic layer 12 and a protective layer 13. The breathable eco-friendly base material 11 forms a bag shape to accommodate the desiccant 20. The antistatic layer 12 is disposed on an outer side of the breathable eco-friendly base material 11 (i.e., the side of the breathable eco-friendly base material 11 located farther away from the desiccant 20), and the antistatic layer 12 includes an antistatic agent. The protective layer 13 is disposed on one side of the antistatic layer 12 located farther away from the breathable eco-friendly base material 11. The desiccant 20 is accommodated in the packaging bag 10.

In some embodiments, the breathable eco-friendly base material 11 may be paper, such as kraft paper. In some embodiments, the packaging bag 10 may further comprise an adhesive layer 14. The adhesive layer 14 is disposed on an inner side of the breathable eco-friendly base material 11 (i.e., the side of the breathable eco-friendly base material 11 located closer to the desiccant 20) and includes a water-based hot-melt adhesive. The water-based hot-melt adhesive is configured to bond edges of the breathable eco-friendly base material 11 after the breathable eco-friendly base material 11 is folded, thereby forming a bag-shaped structure.

It should be noted that the adhesive layer 14 is an optional material. In other embodiments, the packaging bag 10 may omit the adhesive layer 14, and after the breathable eco-friendly base material 11 is folded, its edges may be bonded by heat sealing or stitching, thereby forming a bag-shaped structure.

In some embodiments, the antistatic agent in the antistatic layer 12 may be a water-based antistatic agent, such as an aqueous surfactant solution or a solvent-based antistatic coating.

In some embodiments, the antistatic layer 12 may further comprise a filler. The antistatic layer 12 is a single-layer structure in which the antistatic agent and the filler are mixed. The filler allows the antistatic agent to be uniformly distributed on the breathable eco-friendly base material 11, and can also improve the adhesion durability of the antistatic agent. The filler may be selected from a group consisting of water-based acrylic, bio-based resin, polylactic acid, starch-based adhesive, water-based polyurethane, acrylic acid, water-based emulsion-type hot-melt adhesive, silicone-based hot-melt adhesive, polyurethane hot-melt adhesive, and polyolefin hot-melt adhesive.

It should be noted that if the material selected for the breathable eco-friendly base material 11 already enables the antistatic agent to be uniformly distributed on it during the formation of the antistatic layer 12, the filler in the antistatic layer 12 may be omitted.

In some embodiments, the protective layer 13 may include a water-based hot-melt adhesive, which can enhance the sealing and structural stability of the packaging bag 10.

In the above embodiments, by configuring the packaging bag 10 to include the breathable eco-friendly base material 11, which forms the bag-shape to accommodate the desiccant 20, and the antistatic layer 12 disposed on the outer side of the breathable eco-friendly base material 11 and including the antistatic agent, the packaging bag 10 can achieve antistatic functionality while also being recyclable and environmentally friendly in compliance with ESG and SDGs principles.

In addition, by using the water-based antistatic agent, which is made of environmentally friendly material, in the antistatic layer 12, the eco-friendly requirements can be further satisfied.

It should be noted that if the antistatic layer 12 is not required to be recyclable, the antistatic agent in the antistatic layer 12 may be made of a non-environmentally friendly material. For example, the antistatic agent may be a phosphate ester-type antistatic agent, a polyethylene glycol/polyurethane antistatic agent, a polyvinyl alcohol/conductive polymer antistatic agent, or a water-based acrylic antistatic agent.

In the above configuration, the packaging bag 10 of the aforementioned embodiments can meet the antistatic performance requirements specified by the Electrostatic Discharge Association of the United States (ANSI/ESD S541). According to the ANSI/ESD S541 standard, the surface resistance of a packaging material with antistatic capability must be greater than or equal to 1×10⁴ ohms and less than 1×10¹¹ ohms. The packaging bag 10 of the above embodiments has a surface resistance of approximately 10⁷ ohms, thereby complying with the antistatic capability defined in the standard.

On the other hand, the breathable eco-friendly base material 11, made of paper (such as kraft paper), can enhance air permeability and moisture absorption, and has water adsorption properties, which help suppress and reduce the generation of static charges. It should be noted that the breathable eco-friendly base material 11 is not limited to paper. In other embodiments, the breathable eco-friendly base material 11 may be made of other materials that are recyclable or compliant with ESG and SDGs principles.

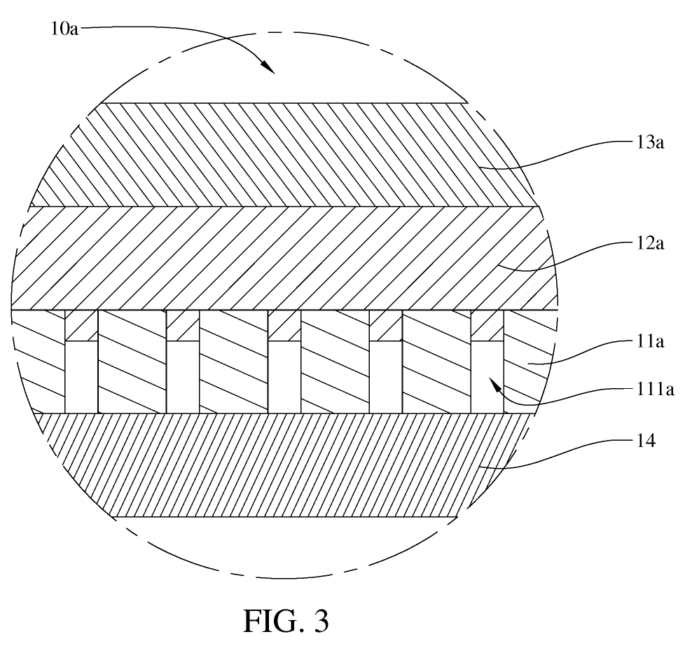

Then, referring to FIG. 3, FIG. 3 is a partial cross-sectional view of a packaging bag 10a according to some embodiments of the disclosure. The structural features of FIG. 3 can be applied to other embodiments of the disclosure.

The packaging bag 10a of the embodiment shown in FIG. 3 is similar to the packaging bag 10 illustrated in FIG. 1. Therefore, the following descriptions mainly focus on the differences between them, and the same parts may refer to the above paragraphs and will not be described in detail again.

In the embodiment shown in FIG. 3, a breathable eco-friendly base material 11a of the packaging bag 10a is long-fiber paper. The term “long-fiber paper” refers to paper having fibers with a length of 2 mm or more. The raw materials of the breathable eco-friendly base material 11a may include softwood pulp, bleached or unbleached kraft pulp, recycled long-fiber pulp, or synthetic fibers. The long-fiber paper provides good air permeability and offers improved adhesion for coated materials.

In some embodiments, the breathable eco-friendly base material 11a is provided with a plurality of microporous structures 111a formed through perforation process. For example, these microporous structures 111a may be formed in the breathable eco-friendly base material 11a through laser perforation process. In embodiments where the breathable eco-friendly base material 11a is made of long-fiber paper, these microporous structures 111a differ from the randomly distributed pores formed by interwoven fibers; instead, they are pores formed at predetermined positions and in predetermined arrangements, with predetermined spacing and shape according to specific processing techniques. This allows the air permeability of the breathable eco-friendly base material 11a to be increased in a controlled manner that meets design specifications, thereby promoting air permeability and moisture regulation. During the coating of the antistatic layer 12a onto the breathable eco-friendly base material 11a, a portion of the antistatic agent resides in these microporous structures 111a, and the antistatic layer 12a is subsequently baked and cured. This enhances the antistatic performance and its durability, while also improving the adhesion of the antistatic layer 12a to the breathable eco-friendly base material 11a.

In some embodiments, an adhesive layer 14 of the packaging bag 10a, as described above, includes a water-based hot-melt adhesive. A protective layer 13a of the packaging bag 10a may include a water-based release agent to prevent the antistatic layer 12a from detaching or losing effectiveness.

According to the desiccant package and the packaging bag as disclosed in the above embodiments, by configuring the packaging bag to include the breathable eco-friendly base material , which forms the bag-shape to accommodate the desiccant, and the antistatic layer disposed on the outer side of the breathable eco-friendly base material and including the antistatic agent, the packaging bag can achieve antistatic functionality while also being recyclable and environmentally friendly in compliance with ESG and SDGs principles.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A desiccant package, comprising:
a packaging bag, comprising:
a breathable eco-friendly base material, forming a bag shape;
an antistatic layer, disposed on an outer side of the breathable eco-friendly base material and comprising an antistatic agent; and
a protective layer, disposed on one side of the antistatic layer located farther away from the breathable eco-friendly base material; and
a desiccant, accommodated in the packaging bag.

2. The desiccant package according to claim 1, wherein the antistatic layer further comprises a filler.

3. The desiccant package according to claim 2, wherein the antistatic layer is formed as a single-layer structure, and the antistatic agent and the filler are mixed in the single-layer structure.

4. The desiccant package according to claim 2, wherein the filler is selected from a group consisting of water-based acrylic, bio-based resin, polylactic acid, starch-based adhesive, water-based polyurethane, acrylic acid, water-based emulsion-type hot-melt adhesive, silicone-based hot-melt adhesive, polyurethane hot-melt adhesive, and polyolefin hot-melt adhesive.

5. The desiccant package according to claim 1, wherein the breathable eco-friendly base material is provided with a plurality of microporous structures formed through perforation process, and the antistatic agent is partially located in the plurality of microporous structures.

6. The desiccant package according to claim 5, wherein the plurality of microporous structures are formed in the breathable eco-friendly base material through laser perforation process.

7. The desiccant package according to claim 1, wherein the breathable eco-friendly base material is paper.

8. The desiccant package according to claim 7, wherein the breathable eco-friendly base material is long-fiber paper or kraft paper.

9. The desiccant package according to claim 1, wherein the antistatic agent is a water-based antistatic agent.

10. The desiccant package according to claim 1, wherein the packaging bag further comprises an adhesive layer, the adhesive layer is disposed on an inner side of the breathable eco-friendly base material; wherein each of the adhesive layer and the protective layer comprises a water-based hot-melt adhesive, or wherein the adhesive layer comprises a water-based hot-melt adhesive and the protective layer comprises a water-based release agent.

11. A packaging bag, adapted to accommodate a desiccant, comprising:
a breathable eco-friendly base material, forming a bag shape to accommodate the desiccant;
an antistatic layer, disposed on an outer side of the breathable eco-friendly base material and comprising an antistatic agent; and
a protective layer, disposed on one side of the antistatic layer located farther away from the breathable eco-friendly base material.

12. The packaging bag according to claim 11, wherein the antistatic layer further comprises a filler.

13. The packaging bag according to claim 12, wherein the antistatic layer is formed as a single-layer structure, and the antistatic agent and the filler are mixed in the single-layer structure.

14. The packaging bag according to claim 12, wherein the filler is selected from a group consisting of water-based acrylic, bio-based resin, polylactic acid, starch-based adhesive, water-based polyurethane, acrylic acid, water-based emulsion-type hot-melt adhesive, silicone-based hot-melt adhesive, polyurethane hot-melt adhesive, and polyolefin hot-melt adhesive.

15. The packaging bag according to claim 11, wherein the breathable eco-friendly base material is provided with a plurality of microporous structures formed through perforation process, and the antistatic agent is partially located in the plurality of microporous structures.

16. The packaging bag according to claim 15, wherein the plurality of microporous structures are formed in the breathable eco-friendly base material through laser perforation process.

17. The packaging bag according to claim 11, wherein the breathable eco-friendly base material is paper.

18. The packaging bag according to claim 17, wherein the breathable eco-friendly base material is long-fiber paper or kraft paper.

19. The packaging bag according to claim 11, wherein the antistatic agent is a water-based antistatic agent.

20. The packaging bag according to claim 11, further comprising an adhesive layer, wherein the adhesive layer is disposed on an inner side of the breathable eco-friendly base material; wherein each of the adhesive layer and the protective layer comprises a water-based hot-melt adhesive, or wherein the adhesive layer comprises a water-based hot-melt adhesive and the protective layer comprises a water-based release agent.
